(19) United States
(12) Patent Application Publication
(10) Pub. No.: US 2026/0122161 A1
(43) Pub. Date: Apr. 30, 2026

(54) MOUNTING FRAME

(71) Applicant: TILTA INC., Burbank, CA (US)

(72) Inventors: Zhichao FENG, Shenzhen (CN); Wenping ZENG, Shenzhen (CN); Kefeng ZHOU, Shenzhen (CN)

(21) Appl. No.: 19/368,966

(22) Filed: Oct. 24, 2025

(30) Foreign Application Priority Data
Oct. 30, 2024 (CN) 202422642865.X

(51) Int. Cl. H04M 1/02

(52) U.S. Cl. CPC H04M 1/0203

(57) ABSTRACT

A mounting frame include a housing and a first protective pad. The housing includes a mounting space for installing an electronic device and is equipped with an opening. The first protective pad is fitted with the opening, with one end situated within the mounting space and the other end extending externally through the opening. In one example, the first protective pad is securely interfitted with the opening, thereby minimizing the likelihood of detachment. This ensures a stable connection between the first protective pad and the housing, effectively providing protection and enhancing the user experience.

### CROSS-REFERENCE TO RELATED APPLICATIONS

The present application for patent claims priority to and the benefit of pending Chinese Application No. 202422642865.X, filed Oct. 30, 2024, and hereby expressly incorporated by reference herein as if fully set forth below in its entirety and for all applicable purposes.

### TECHNICAL FIELD

The present disclosure pertains to the technical field of electronic device accessories, specifically to a mounting frame.

### INTRODUCTION

In daily life, electronic devices such as mobile phones and tablets have become indispensable tools. People frequently use these devices for activities like watching videos and working. The widespread adoption of electronic devices has led to the extensive use of electronic device accessories, such as protective cases. Currently, mobile phone cases on the market often feature silicone pads adhered to the four corners for protection. However, during prolonged use, these silicone pads are prone to detachment due to adhesive failure, adversely affecting the user experience.

### BRIEF SUMMARY

Aspects of the present disclosure provide a mounting frame that addresses the issue of silicone pads detaching during long-term use, which compromises the user experience.

Some aspects of the present disclosure provide:
a mounting frame including:
a housing with a mounting space for an electronic device and equipped with a an opening;
a first protective pad interfitted with the opening, with one end located within the mounting space and the other end extending externally through the opening.

In some aspects, the first protective pad is positioned on the mounting frame as a mobile phone case. When the phone in the mobile phone case is placed flat on a surface, the first protective pad protrudes relative to the housing, making contact with the surface. This prevents the camera lens of the phone from touching the surface, thereby protecting the lens. Additionally, the first protective pad on the housing provides an anti-slip function, reducing the likelihood of the phone being dropped and thus protecting the phone in the mounting frame. Furthermore, the secure interfitting of the first protective pad with the opening minimizes the chance of detachment, ensuring a firm connection to the housing for protection and effectively enhancing the user experience.

### BRIEF DESCRIPTION OF THE DRAWINGS

To elucidate the technical solutions presented in the exemplary embodiments of the present disclosure, the accompanying drawings for describing these embodiments will be briefly introduced below. It is apparent that the accompanying drawings described herein represent merely some embodiments of the present application. For those skilled in the art, without the necessity for inventive effort, other drawings can be derived based on the structures depicted in these drawings.

FIG. 1 is a schematic diagram illustrating a mounting frame installed with an electronic device according to aspects of the disclosure.

FIG. 2 is a schematic diagram illustrating a second housing of the mounting frame.

FIG. 3 is an enlarged view of section A in FIG. 2.

FIG. 4 is a diagram illustrating a first protective pad according to aspects of the disclosure.

FIG. 5 is an exploded view of the mounting frame of according to aspects of the disclosure.

FIG. 6 is an enlarged view of section B in FIG. 5.

FIG. 7 is a schematic diagram of a first housing and the second housing prior to assembly.

FIG. 8 is a schematic diagram of the first housing and the second housing after assembly.

FIG. 9 is another schematic diagram of the first housing and the second housing after assembly.

### REFERENCE NUMERALS

10. Mounting Frame; 20. Electronic Device;
1. Housing; 11. First Housing; 12. Second Housing; 121. Mounting Space; 122. Hole; 1221. First Limiting Protrusion; 123. Second Limiting Protrusion; 124. Positioning Post; 125. Accommodation Groove; 126. Wire Pass Channel; 127. First Mounting Port; 128. Second Mounting Port; 129. Electrical Interface; 13. First Opening; 14. Second Opening;
2. First Protective Pad; 21. First Limiting Groove; 22. Second Limiting Groove; 23. Third Limiting Protrusion; 231. Limiting Hole;
3. Circuit board module;
4. Assembly Component; 41. Latching Member; 42. Latching Groove; 43. Locking Member; 431. Locking Pin; 432. Actuation Part; 44. Locking Groove;
5. Second Protective Pad.

The objectives, functional features, and advantages of this disclosure will be further elaborated with reference to the accompanying drawings and in conjunction with specific embodiments.

### DETAILED DESCRIPTION

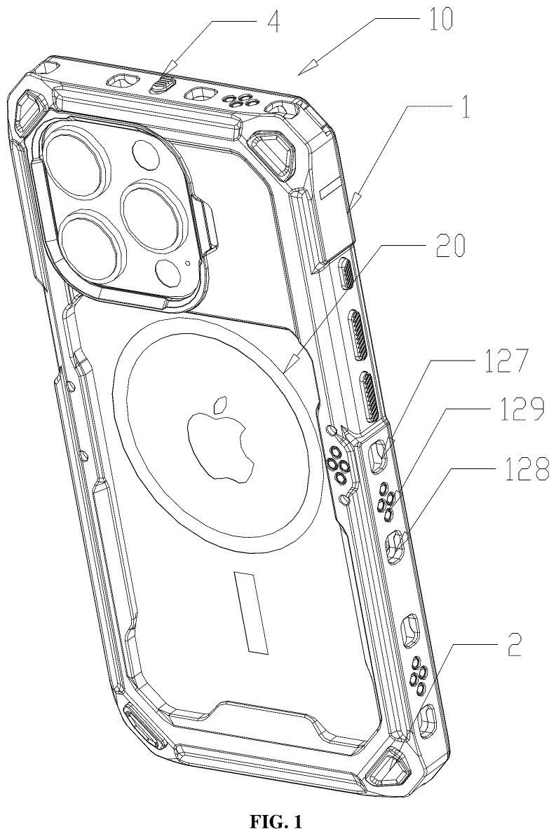

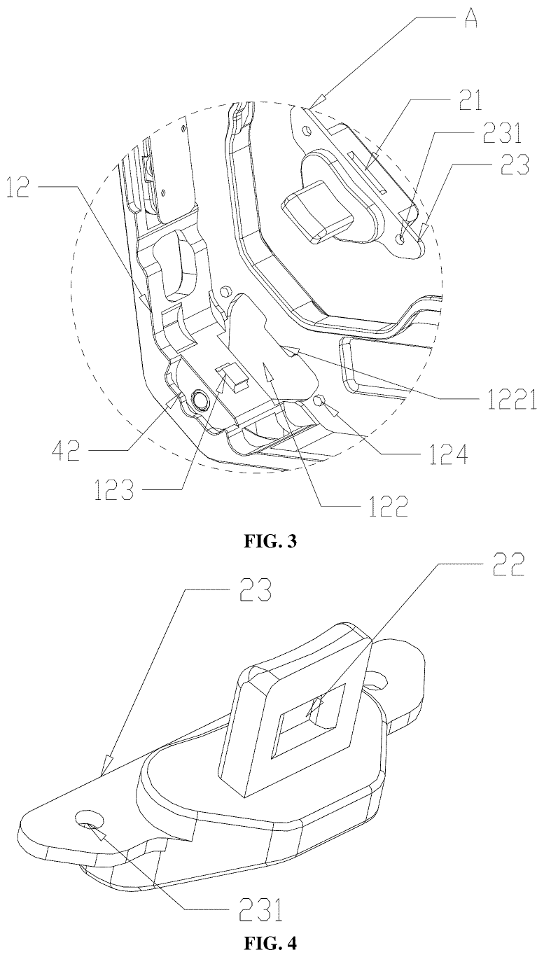

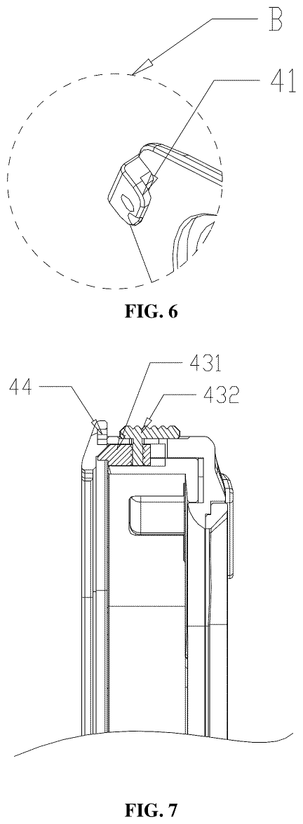

Referring to FIGS. 1-9, the present disclosure introduces a mounting frame 10 configured for installing an electronic device 20 (e.g., a mobile phone). The mounting frame 10 includes a housing 1 and a first protective pad 2. The housing 1 features a mounting space 121 for installing the electronic device 20 therein and is equipped with a hole 122 (an opening). The first protective pad 2 is fitted within the hole 122 (e.g., the first protective pad 2 and the hole 122 are interfitted, with one end situated within the mounting space 121 and the other end extending externally through the hole 122.

In some aspects, the first protective pad 2 is positioned on the mobile phone case (e.g., mounting frame 10). When the phone (installed in the mounting frame) is placed flat on a surface, the first protective pad 2 protrudes relative to the housing 1, making contact with the surface. This prevents the camera lens from touching the surface, thereby protecting it. Additionally, the first protective pad 2 on the housing 1 can provide an anti-slip function, reducing the likelihood of the phone being dropped and thus protecting the phone. For example, the secure interfitting of the first protective pad 2 with the hole 122 minimizes the chance of detachment, ensuring a firm connection to the housing 1 for protection and effectively enhancing the user experience.

In some aspects, one of the hole wall of the hole 122 and the first protective pad 2 can be equipped with a first limiting protrusion 1221, while the other features a first limiting groove 21. The hole wall is a wall surface surrounding the hole 122 (e.g., an opening). The first limiting protrusion 1221 is designed to engage within the first limiting groove 21, restricting the movement of the first protective pad 2 relative to the housing 1 (or the hole 122) and minimizing the likelihood of detachment of the first protective pad 2 from the housing 1.

In some aspects, one of the inner side of the housing 1 facing the mounting space 121 and the first protective pad 2 can be equipped with a second limiting protrusion 123, while the other one features a second limiting groove 22. The second limiting protrusion 123 is designed to engage within the second limiting groove 22, enabling the stable installation of the first protective pad 2 on the housing 1 through multiple limiting structures (e.g., first limiting protrusion 1221, first limiting groove 21, second limiting protrusion 123, and second limiting groove 22).

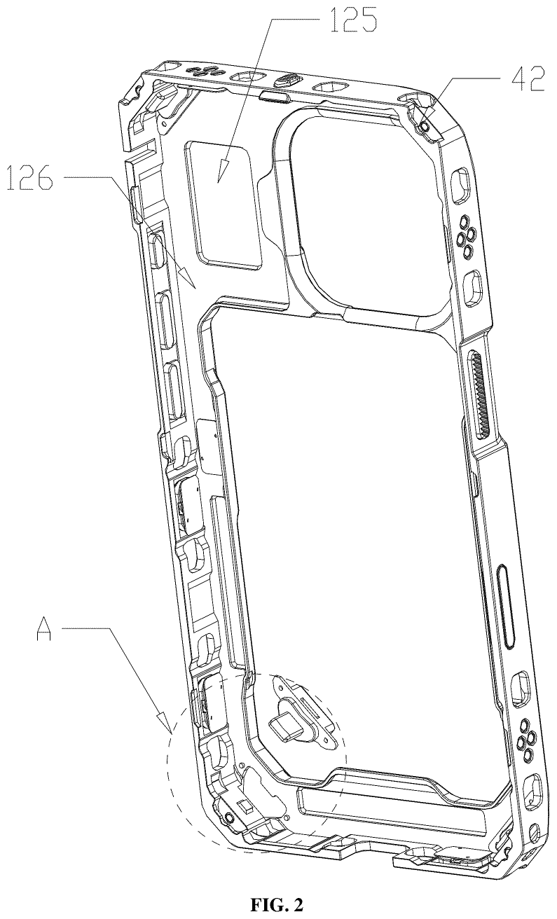

For example, referring to FIGS. 2-4, the first limiting protrusion 1221 is positioned on the hole wall (e.g., wall surface) of the hole 122 (e.g., opening), while the second limiting protrusion 123 is located on the housing 1. Both the first limiting groove 21 and the second limiting groove 22 are formed on the first protective pad 2, positioned on opposite sides. In some aspects, the first protective pad 2 can be crafted from an elastic material, such as rubber or silicone. During installation, the first protective pad 2 can be pressed into the hole 122, causing the first limiting protrusion 1221 and the second limiting protrusion 123 to engage within the first limiting groove 21 and the second limiting groove 22, respectively. Since the first limiting groove 21 and the second limiting groove 22 are located on opposite sides of the first protective pad 2, the first protective pad 2 is restrained from opposite directions, enhancing installation stability.

In some aspects, the outer periphery of the first protective pad 2 can be equipped with a third limiting protrusion 23, capable of abutting against the inner wall of the housing 1 facing the mounting space 121. One of the third limiting protrusion 23 and the housing 1 features a limiting hole 231, while the other has a positioning post 124 designed to fit within the limiting hole 231. The positioning post 124 can be located on the housing 1, and the limiting hole 231 can be on the third limiting protrusion 23. The positioning post 124 protrudes towards the interior of the mounting space 121, enhancing the connection stability between the first protective pad 2 and the housing 1.

In some aspects, referring to FIG. 1, the mounting frame includes multiple first protective pads 2. For example, each of the four corners of the housing 1 is equipped with a hole 122, with four first protective pads 2 interfitted within these holes.

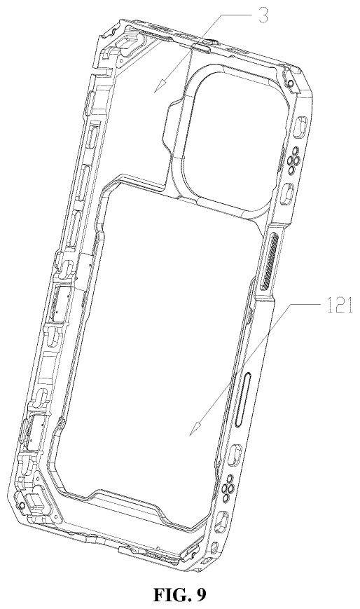

In some aspects, referring to FIGS. 2 and 9, the mounting frame further includes a circuit board module 3 includes a circuit board and a flexible flat cable. The inner wall of the housing 1 facing the mounting space 121 features an accommodation groove 125 and a wire pass channel 126. The circuit board can be housed within the accommodation groove 125, while the flexible flat cable can be accommodated within the wire pass channel 126. The housing 1 can be equipped with multiple first mounting ports 127 and second mounting ports 128, arranged in corresponding pairs. At least one electrical interface 129 can be positioned between at least one corresponding pair of the first mounting port 127 and the second mounting port 128. The circuit board is electrically connected to the electrical interface 129 via the flexible flat cable. This configuration enables the mounting frame 10 to accommodate external accessories and establish electrical connections with them, facilitating user operation. For example, a user can install a mobile phone within the mounting space 121 and expand functionality by attaching accessories such as a light, microphone, or power supply handle via the first mounting ports 127 and second mounting ports 128. These accessories can be electrically connected to the mounting frame 10 through the electrical interfaces 129, enabling the power supply handle to supply power to the light and microphone with electric connection. The electrical interface 129 can include one or more electronic contact pin, with corresponding electronic contact pin(s) on the external accessories for establishing electrical contact upon connection.

In some aspects, the housing 1 includes a first housing 11 and a second housing 12, which are detachably connected together. The second housing 12 is equipped with the mounting space 121, accommodation groove 125, and wire pass channel 126.

The mounting frame 10 further includes an assembly component 4, including a latching member 41 and a latching groove 42. The latching member 41 is positioned on either the first housing 11 or the second housing 12, with the latching groove 42 located on the other. The latching member 41 is designed to engage with the latching groove 42, securing the electronic device 20 within the mounting space 121.

During use, a user first places the electronic device 20 into the mounting space 121 of the second housing 12. The first housing 11 is then positioned over the second housing 12, allowing the latching member 41 to engage within the latching groove 42, thereby swiftly connecting the first housing 11 and the second housing 12. For disassembly, the latching member 41 slides out of the latching groove 42, facilitating a quick separation of the first housing 11 and the second housing 12. As described in this disclosure, the mounting frame 10 described in this disclosure offers ease of installation and disassembly, enhancing the user experience.

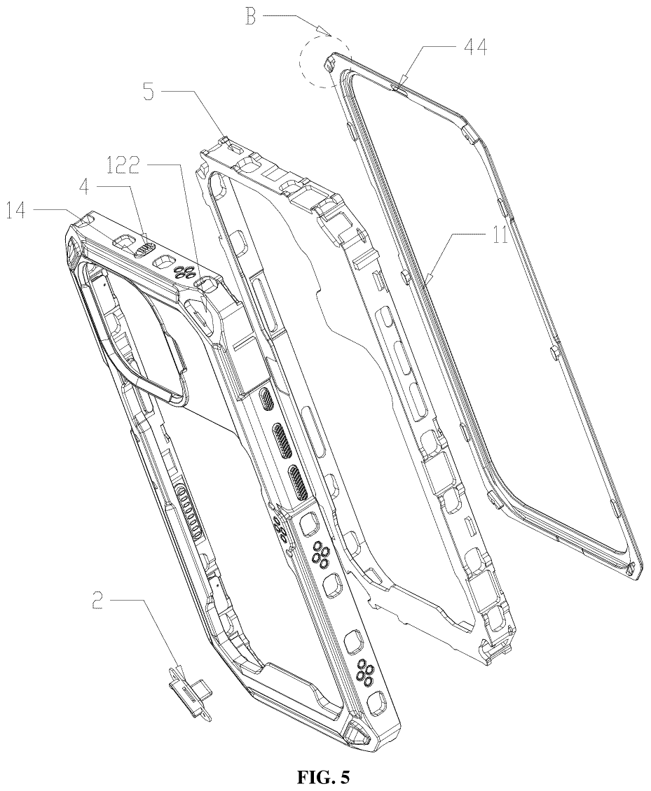

As illustrated in FIGS. 5-8, that the latching member 41 and latching groove 42 can be placed on either the first housing 11 or the second housing 12. In one example, the latching member 41 is on the first housing 11 and the latching groove 42 is on the second housing 12. In one example, when the first housing 11 slides relative to the second housing 12, the latching member 41 fits into the latching groove 42. After the user places the electronic device 20 into the mounting space 121, the user can slide the first housing 11 relative to the second housing 12, causing the latching member 41 to slide into and engage within the latching groove 42, thereby connecting and assembling the first housing 11 and the second housing 12. For removal, the user slides the first housing 11 relative to the second housing 12 in the opposite direction to installation, causing the latching member 41 to slide out of the latching groove 42. The first housing 11 and the second housing 12 can then be separated, allowing the user to remove the electronic device 20. The electronic device 20 can be a mobile phone or a tablet. The latching groove 42 can include multiple grooves distributed along the two side edges of the mounting space 121 of the second housing 12, or it can be a continuous elongated groove on the second housing 12. For example, there can be two elongated grooves on either side of the mounting space 121. Consequently, the shape of the latching member 41 can be adjusted to match the shape of the latching groove 42.

Alternatively, for an arrangement where the latching member 41 is on the second housing 12 and the latching groove 42 is on the first housing 11, equivalent substitutions can be made based on the descriptions provided herein.

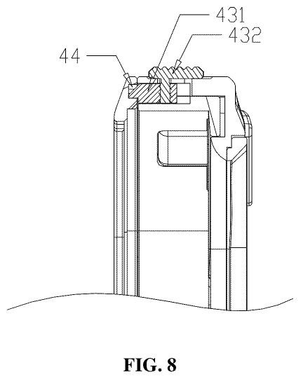

In some aspects, referring to FIGS. 7-8, the assembly component 4 further includes a locking member 43. The locking member 43 is movably connected to either the first housing 11 or the second housing 12, with the other housing featuring a locking groove 44. When the latching member 41 engages with the latching groove 42, the locking member 43 can engage with the locking groove 44 to secure the first housing 11 and the second housing 12. With this setup, after the user mounts the electronic device 20 into the mounting space 121, the user slides the first housing 11 relative to the second housing 12, causing the latching member 41 to slide into and engage within the latching groove 42, and simultaneously causing the locking member 43 to engage with the locking groove 44, thereby locking the first housing 11 and the second housing 12. For removal, the user actuates the locking member 43 to disengage it from the locking groove 44. Then, the user can slide the first housing 11 relative to the second housing 12 in the opposite direction to installation, causing the latching member 41 to slide out of the latching groove 42. The first housing 11 and the second housing 12 can then be separated, allowing the user to remove the electronic device 20.

Referring to FIGS. 5-8, the locking member 43 includes an actuation part 432 and a locking pin 431. The locking pin 431 is elastically positioned on either the first housing 11 or the second housing 12. The actuation part 432 is connected to the locking pin 431 and is capable of driving the locking pin 431 to engage with the locking groove 44. In some embodiments, the locking member 43 can be positioned on either the first housing 11 or the second housing 12, with the other housing featuring the locking groove 44. For example, the locking member 43 can be on the second housing 12. The locking member 43 is elastically positioned on the second housing 12, which has a first opening 13 and a second opening 14. The locking pin 431 is elastically positioned on the second housing 12, with one end capable of extending beyond the first opening 13. The actuation part 432 is connected to the locking pin 431, with one end capable of extending beyond the second opening 14. For example, the locking pin 431 and the actuation part 432 can be secured by threads. A spring is positioned between the locking pin 431 and the second housing 12, enabling the locking pin 431 to be elastically positioned on the second housing 12. For example, multiple springs can be positioned between the locking pin 431 and the second housing 12, evenly distributed on both sides of the actuation part 432.

Referring to FIG. 9, the inner wall of the second housing 12 facing the mounting space 121 can be equipped with a second protective pad 5. The circuit board and the flexible flat cable are placed between the second protective pad 5 and the second housing 12. With this configuration, the second protective pad 5 can protect both the mobile phone, the circuit board, and flexible flat cable. As illustrated in the figures, the mounting frame can include multiple latching grooves 42. The second housing 12 and the second protective pad 5 can work together to form a portion of these latching grooves 42.

Although specific embodiments of the invention have been described in detail, it should be understood that the invention is not limited to the exact configurations and components shown and described. Parts may be substituted, elements may be reversed, and certain features may be used independently of others, all without departing from the scope of the invention as defined by the claims. Various alternatives, modifications, and equivalents will be apparent to those skilled in the art. For example, the shape, dimensions, or materials of components may be varied, and mechanical linkages may be replaced with equivalent mechanisms that perform the same function. Such alternatives are considered to be within the scope of the invention as defined by the following claims.

The drawings and the associated descriptions are provided to illustrate embodiments of the invention and are not intended to limit the scope of the invention. Relative terms such as “upper,” “lower,” “left,” “right,” “front,” and “rear” are used for convenience only and are not intended to limit the invention to any particular orientation.

What is claimed is:

1. A mounting frame, comprising:
a housing configured to provide an opening and a mounting space for mounting an electronic device; and
a first protective pad positioned in the opening, wherein a first end of the first protective pad is located in the mounting space, and a second end, opposite the first end of the first protective pad, extends through the opening to protrude outside the housing.

2. The mounting frame according to claim 1, wherein a first limiting protrusion is provided on one of a wall surface surrounding the opening and the first protective pad, and a first limiting groove is provided on the other one of the wall surface surrounding the opening and the first protective pad; and
wherein the first limiting protrusion is configured to engage within the first limiting groove.

3. The mounting frame according to claim 2, wherein a second limiting protrusion is provided at one of an inner side of the housing facing the mounting space and the first protective pad, and a second limiting groove is provided at the other one of the inner side of the housing facing the mounting space and the first protective pad; and
wherein the second limiting protrusion is configured to engage with the second limiting groove.

4. The mounting frame according to claim 3, wherein the first limiting protrusion is disposed at the opening, the second limiting protrusion is disposed at the housing; and
wherein the first limiting groove and the second limiting groove are respectively provided on two opposite sides of the first protective pad.

5. The mounting frame according to claim 1, wherein a third limiting protrusion is provided at an outer periphery of the first protective pad; and
wherein the third limiting protrusion is conformable to an inner wall of the housing facing the mounting space.

6. The mounting frame according to claim 5, wherein a limiting hole is provided at one of the third limiting protrusion and the housing, and a positioning post is provided at the other one of the third limiting protrusion and the housing; and
wherein the positioning post is receivable in the limiting hole.

7. The mounting frame according to claim 1, wherein the first protective pad comprises a plurality of protective pads,
wherein four openings are provided respectively at four corners of the housing; and
wherein four of the plurality of protective pads are respectively engaged in the four openings.

8. The mounting frame according to claim 1, wherein the mounting frame further comprises a circuit board module;
wherein an accommodation groove and a wire pass channel are formed on an inner wall of the housing facing the mounting space;
wherein the circuit board module is configured to be received in the accommodation groove;
wherein the flexible flat cable is configured to be received in the wire pass channel;
wherein the housing is provided with multiple first mounting ports and multiple second mounting ports;
wherein the first mounting ports correspond to the second mounting ports in one-to-one manner;
wherein an electrical interface is disposed between at least one of the first mounting ports and a corresponding one of the second mounting ports; and
wherein the circuit board module is electrically connected to the electrical interface.

9. The mounting frame according to claim 8, wherein the housing comprises a first housing and a second housing;
wherein the first housing and the second housing are detachably connected;
wherein the second housing is provided with the mounting space; and
wherein the accommodation groove and the wire pass channel are provided in the second housing.

10. The mounting frame according to claim 9, wherein a second protective pad is provided at an inner wall of the second housing facing the mounting space; and
wherein the circuit board module is disposed between the second protective pad and the second housing.
